(19) United States
(12) Patent Application Publication
(10) Pub. No.: US 2023/0004139 A1
(43) Pub. Date: Jan. 5, 2023

(54) MONITORING SUPPORT DEVICE AND MONITORING SUPPORT METHOD

(71) Applicant: HITACHI, LTD., Tokyo (JP)

(72) Inventors: Yuya TOKUDA, Tokyo (JP); Takuya YOSHIDA, Tokyo (JP)

(21) Appl. No.: 17/781,460

(22) PCT Filed: Oct. 7, 2020
(86) PCT No.: PCT/JP2020/038023

§ 371 Date: Jun. 1, 2022

(30) Foreign Application Priority Data
Dec. 3, 2019 (JP) 2019-218643

(51) Int. Cl. G05B 19/406

(52) U.S. Cl. CPC G05B 19/406; G05B 2219/34427

(57) ABSTRACT

A processing device (40) has: a plant control unit (24) that obtains, from an inputted process value (11), a manipulated variable (25) to be outputted in accordance with a control rule (22) and that outputs the manipulated variable to plant equipment; a monitoring necessity determination unit (34) that obtains, from the inputted process value (11), a monitoring level to be outputted in accordance with a monitoring condition signal (32) and that notifies a plant operator of the monitoring level; and a monitoring condition learning unit (31) that, when history data of the process value (11) is inputted as learning data, causes a monitoring condition storage unit (33) to store the monitoring condition signal (32) associated with the monitoring level with respect to a range of a current process value (11) on the basis of a probability of transition from the current process value (11) to a future process value (11).

### TECHNICAL FIELD

The present invention relates to a monitoring support device and a monitoring support method.

### BACKGROUND ART

An administrator of an industrial plant (power generation, chemical and so forth) tries to improve yield/efficiency of the plant by introducing intellectual control which applies artificial intelligence field technologies such as a neural network, reinforcement learning and so forth. A learning device for the intellectual control derives an optimum control law from past plant operation data by a statistical analysis. A control device which operates in accordance with the control law can realize a high control performance limitedly in a range that past plant operation data is present.

On the other hand, in a range that the past plant operation data is not present, it becomes necessary to protect plant components.

In Patent Literature 1, a method of predicting a future plant state of a plant by iteration calculations of a simulator and a control device of the plant and optimally selecting a limiting value of a manipulated variable so as not to activate a protection function of the plant components and to normalize the plant state is disclosed.

In Patent Literature 2, a method of making it learn in advance a feature amount of a monitoring sensor signal by a predictive diagnosis function and preparing a standard of a divergence degree is disclosed. In a case where the divergence degree reaches a certain threshold value, switching to fallback becomes possible.

### PATENT LITERATURE

Patent Literature 1: Japanese Patent Application Laid-Open No. Sho 60-93507

Patent Literature 2: Japanese Patent Application Laid-Open No. 2018-060387

### SUMMARY OF INVENTION

### Technical Problem

As described in the Patent Literature 1, protection of the components becomes possible by switching the control when a process value deviates from a margin. On the other hand, appropriate margin setting is difficult. When the margin is small, there is a risk that the components would be damaged. When it is large, an operating time for artificial intelligence control becomes short and a plant efficiency is lowered.

As described in the Patent Literature 2, the control can be switched at an early stage by defining data which has been learned as an experience range and by deciding whether the artificial intelligence control is applicable depending on whether it deviates from that range. However, it is difficult to define a relevancy with a personally set restriction and it is difficult to improve a decision accuracy.

Therefore, a plant operator monitors the process value and decides to switch to a general control mode or a protection control mode and thereby it is expected that an optimum control mode which accords with the situation will be adopted. However, when the plant operator judges control modes of all plants in all time zones, a monitoring load on the plant operator is increased and human fatigue occurs.

On the other hand, there also exists a scene that the plant operator watches out in particular. For example, at an initial stage that an intellectual control system is applied to the plant, the plant operator adjusts the system finely in order to increase a control performance to an expected level. On this occasion, for example, in a case where it is necessary to conduct re-learning with the use of freshly acquired data, it is difficult to predict a time which is required for adjustment. In this adjustment period, it is necessary for the plant operator to make effort for stable control of the plant with particular caution.

Accordingly, the present invention mainly aims to provide information which is useful for reducing a monitoring load thereon while making the plant operator conduct monitoring in an appropriate situation as a main issue.

### Solution to Problem

In order to solve the aforementioned issue, a monitoring support device according to the present invention has following characteristics.

The present invention is characterized by having

a control law storage section in which a control law that a suitable operation signal is put into correspondence with a process value that operation data of a plant component is measured is stored,

a monitoring condition storage section in which a monitoring condition that a monitoring degree which indicates a degree of necessity/non-necessity of monitoring is put into correspondence with a range of the process values is stored,

a plant control section which obtains the operation signal which is to be output in accordance with the control law from the process value which is input and outputs it to the plant component,

a monitoring necessity/non-necessity processing section which obtains the monitoring degree which is to be output in accordance with the monitoring condition from the process value which is input and notifies a plant operator of it and

a monitoring condition learning section which prepares the monitoring condition by putting the monitoring degree into correspondence with the range of the current process values on the basis of a probability of shifting from the current process value to the future process value when history data of the process value is input as learning data and makes the monitoring condition storage section store that monitoring condition.

Other means will be described later.

### Advantageous Effects of Invention

According to the present invention, it becomes possible to provide the information which is useful for reducing a monitoring load thereon while making the plant operator conduct the monitoring in the appropriate situation.

### BRIEF DESCRIPTION OF DRAWINGS

FIG. 1 is a configuration diagram of a plant control system relating to one embodiment of the present invention.

FIG. 2 is a flowchart showing processing of a monitoring condition learning section relating to one embodiment of the present invention.

FIG. 3 is a time-series graph which shows a process value of operation data relating to one embodiment of the present invention.

FIG. 4 is a configuration diagram of a state conversion table relating to one embodiment of the present invention.

FIG. 5 is a table which shows one example of a state transition matrix T relating to one embodiment of the present invention.

FIG. 6 is a diagram showing one example of an attenuation type state transition matrix D relating to one embodiment of the present invention.

FIG. 7 is a diagram showing a flow of processing that a monitoring necessity/non-necessity decision section relating to one embodiment of the present invention performs.

FIG. 8 is a monitoring target table which shows one example of a normal range decision matrix R relating to one embodiment of the present invention.

FIG. 9 is a table which shows monitoring necessity/non-necessity signals relating to one embodiment of the present invention.

FIG. 10 is a diagram of screens which are displayed in a monitoring room relating to one embodiment of the present invention.

### Description of Embodiments

In the following, one embodiment of the present invention will be described in detail with reference to the drawings.

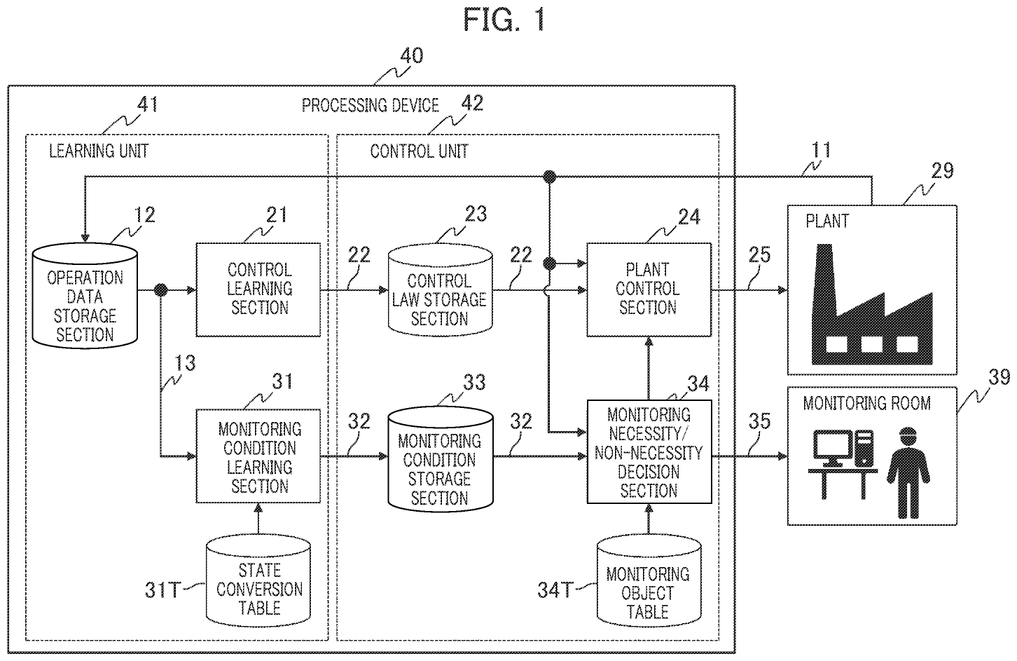

FIG. 1 is a configuration diagram of a plant control system.

The plant control system is configured with a plant 29, a processing device 40 and a monitoring room 39 being mutually connected over a network.

The plant 29 is configured as, for example, a power generation plant and a chemical plant. Incidentally, the plant 29 is one example of a control object and may be also applied to other control objects (a motor vehicle, a robot, an electric train and so forth). The plant 29 operates by appropriately switching from mechanical learning control by the processing device 40 to manual control from the monitoring room 39 and vice versa. Thereby, even when an unexpected situation that mechanical learning is not conducted occurs, the plant control system is stably controlled by intervention of human-based judgement.

The processing device 40 is configured as a computer which has a CPU (Central Processing Unit), a memory, a storage means (a storage unit) such as a hard disc and so forth and a network interface.

The CPU executes a program (also called an application and app. which is an abbreviation thereof) which is read on the memory and thereby this computer makes a control unit (a control means) which is configured by respective processing sections operate.

The processing device 40 has a learning unit 41 which conducts mechanical learning and a control unit 42 which conducts processing which relates to control of the plant 29 by using a result of learning by the learning unit 41. The learning unit 41 has an operation data storage section 12, a control learning section 21, a monitoring condition learning section 31 and a state conversion table 31T. The control unit 42 has a control law storage section 23, a plant control section 24, a monitoring condition storage section 33, a monitoring necessity/non-necessity decision section 34 and a monitoring object table 34T.

These constitutional elements of the processing device 40 are classified into the following two systems.

(1) An automatic control system is, a signal flows in the order of the operation data storage section 12→(operation data 13)→the control learning section 21→(a control law 22)→the control law storage section 23→(the control law 22)→the plant control section 24→(a manipulated variable 25)→the plant 29.

In this automatic operation system, a relation between a past process value 11 and a past control signal (the manipulated variable 25) is learned in advance and an optimum signal (an operation signal) is output to the process value 11 which is input from the plant 29.

(2) A manual control system is, the signal flows in the order of the operation data storage section 12→(the operation data 13)→the monitoring condition learning section 31→(a monitoring condition signal 32)→the monitoring condition storage section 33→(the monitoring condition signal 32)→the monitoring necessity/non-necessity decision section 34→(a monitoring necessity/non-necessity signal 35)→the monitoring room 39.

In this manual control system, a relation between control signals (the process value 11 which is input and the manipulated variable 25 which is output) and deviation thereof from a range (in the following, “a protection range”) of the process value 11 for protection of the component is learned in advance. Then, in a case where, as a result that the control signal is monitored, it is predicted that it deviates from the protection range, it is notified to the plant operator. Thereby, the plant operator manually controls the plant 29 on the basis of his/her own judgement.

The process value 11 which indicates an operation state of the plant 29 is stored in the operation data storage section 12 as the operation data 13. The operation data 13 is time-series data of the process value 11.

The control learning section 21 learns the control law 22 with the operation data 13 which is stored in the operation data storage section 12 being input and outputs it to the control law storage section 23. The control learning section 21 sets an already-learned network which is constructed on the basis of, for example, a neural network theory that the operation data 13 is set as the learning data as the optimum control law 22. Otherwise, the control learning section 21 may obtain a function of the manipulated variable 25 relative to the process value 11 and may set that function as the control law 22.

The plant control section 24 sets the process value 11 as an input signal relative to the control law 22 of the control law storage section 23 and thereby calculates an output signal therefrom as the manipulated variable 25. This manipulated variable 25 is input into the plant 29 as a control signal.

The monitoring condition learning section 31 outputs the monitoring condition signal 32 with reference to the state conversion table 31T with the operation data 13 which is stored in the operation data storage section 12 being input.

The monitoring condition signal 32 is stored in the monitoring condition storage section 33. The monitoring condition signal 32 is a signal which contains information which indicates the relation that the control signals (the process value 11 and the manipulated variable 25) deviate from their protection ranges respectively.

The monitoring necessity/non-necessity decision section 34 outputs the monitoring necessity/non-necessity signal 35 with the monitoring condition signal 32 of the monitoring condition storage section 33 and the process value 11 from the plant 29 being input. The monitoring necessity/non-necessity signal 35 is a signal which indicates a result of decision of monitoring necessity/non-necessity by the plant operator.

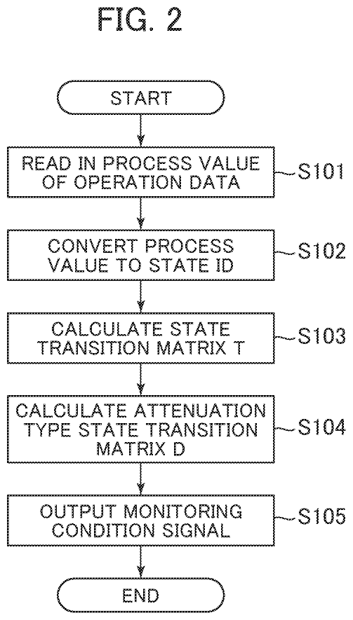

FIG. 2 is a flowchart showing processing of the monitoring condition learning section 31.

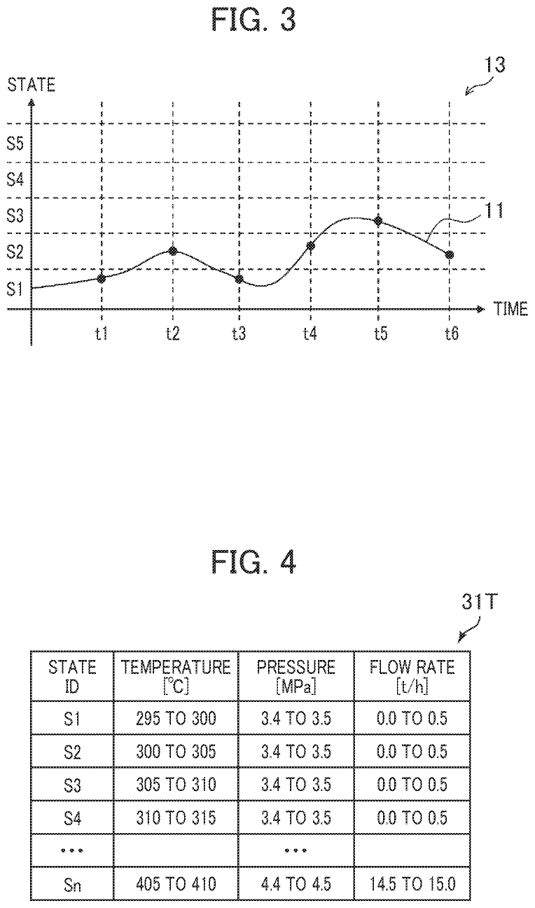

The monitoring condition learning section 31 reads in the process value 11 in the operation data which is stored in the operation data storage section 12 (S101). The monitoring condition learning section 31 converts each-time process value 11 which is read in into a state ID in accordance with the state conversion table 31T (S102, details are in FIG. 3, FIG. 4).

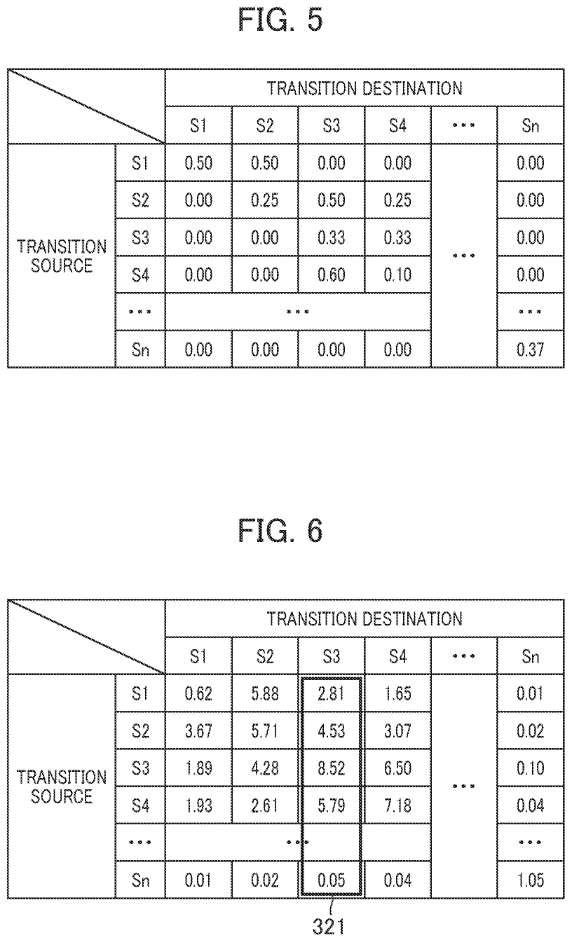

The monitoring condition learning section 31 calculates a state transition matrix T which is one step ahead on the basis of the each-time state ID which is converted in S102 (S103, details are in FIG. 5). The monitoring condition learning section 31 calculates an attenuation type state transition matrix D from one step ahead to N step ahead from the state transition matrix T which is calculated in S103 (S104, details are in FIG. 6). The monitoring condition learning section 31 makes the monitoring condition storage section 33 store the attenuation type state transition matrix D which is calculated in S104 as the monitoring condition signal 32 (S105).

FIG. 3 is a time-series graph which shows the process value 11 in the operation data 13.

Measurement data on the process value 11 of a temperature and so forth is stored into the operation data storage section 12 as the time-series graph. Here, the measurement data is classified into any one of state IDs in accordance with a range of numerical values which are registered in advance into the state conversion table 31T in FIG. 4. FIG. 4 is a configuration diagram of the state conversion table 31T.

The state conversion table 31T puts numerical value ranges thereof into correspondence with the state IDs by type of the process values 11 of a temperature, a pressure, a flow rate and so forth. The process values 11 are internal measurement data on components which configure one optional plant 29. The state ID is the one which classifies the pattern of the process value 11 by number.

The state ID “S1” is a state that the temperature is in a range of 295 to 300 [° C.], and the pressure is in a range of 3.4 to 3.5 [MPa], and the flow rate is in a range of 0.0 to 0.5 [t/h]. The state ID “S2” is a state that the temperature is in a range of 300 to 305 [° C.], and the pressure is in a range of 3.4 to 3.5 [MPa], and the flow rate is in a range of 0.0 to 0.5 [t/h].

Incidentally, although in FIG. 4, the state IDs are allocated by partitioning it to the numerical value ranges from an upper limit to a lower limit, for example, a continuous value may be used also as data which indicates the inner state of the plant 29.

Returning to FIG. 3, the monitoring condition learning section 31 receives the time-series graph of the process value 11 and refers to the state conversion table 31T and thereby converts the process value 11 to the state ID step by step (6 steps in total at times t1 to t6). For example, the process value 11 at the time t1 is converted to the state ID “S1”, the process value 11 at the time t2 is converted to the state ID “S2”. Here, a time length of one step is, for example, one hour.

That is, the monitoring condition learning section 31 converts the process value 11 in FIG. 3 into such a transition list of the state IDs of “S1→S2→S1→S2→S3→S2” in the order from the time t1. FIG. 5 is a table which shows one example of the state transition matrix T.

A probability when a certain state which is indicated by the state ID is defined as a transition source and the state of the next step is defined as a transition destination is defined as an “order transition rate”. There are cases where a state of the transition destination stays in a state which is the same as the state of the transition source and changes to a state which is different from the state of the transition source.

The state transition matrix T indicates the order transition rate in a combination of each state ID (S1, S2, . . . , Sn) of the transition source with each state ID (S1, S2, . . . , Sn) of the transition destination in the next step. Although 0- to 1-order transition rates are input into the respective cell values, in the following description, a description will be given with the order transition rates being set from 0% to 100%.

Focusing on the state ID “S1” of the transition source, the state which becomes the transition destination in the next step from that state ID “S1” is divided into a case of the order transition rate 50% that it stays in the same state¥ ID “S1” and a case of the order transition rate 50% that it transits to another state ID “S2”. Focusing on the state ID “S2” of the transition source, the state which becomes the transition destination from that state ID “S2” in the next step is divided into a case of the order transition rate 25% that it stays in the same ID “S2”, a case of the order transition rate 50% that it transits to the state ID “S3”, and a case of the order transition rate 25% that it transits to the state ID “S4”.

For example, focusing on the state ID “S1” of the transition source from the transition list “S1→S2→S1→S2→S3→S2” which is prepared from FIG. 3, the monitoring condition learning section 31 prepares the state transition matrix T by conducting such aggregation that it transits to the state ID “S2” two times in the next step.

FIG. 6 is a diagram showing one example of the attenuation type state transition matrix D.

The attenuation type state transition matrix D is a table that the transition rate of each combination of the state of the transition source with the state of the transition destination is stored just like the state transition matrix T (a sign 321 will be described later in description of FIG. 9). A difference between the attenuation type state transition matrix D and the state transition matrix T is the following. The state transition matrix T stores one-step-ahead order transition rates while the state transition matrix T stores a long-term transition rate up to N steps ahead (ideally, infinite steps ahead).

The monitoring condition learning section 31 accumulates the one-step order transition rates and thereby calculates the long-term transition rate. For example, in the state transition matrix T, focusing on the state ID “S1” of the transition source at a time t1, the order transition rate at a time t2 becomes the state ID “S1” (50%) or the state ID “S2” (50%). Supposing that it transits to the state ID “S2” at the time t2, in the state transition matrix T from the state ID “S2” of the transition source, the state ID “S3” (50%) of the transition destination is a high order transition rate at the time t3. Accordingly, the long-term transition rate from the state ID “S1” of the transition source to the state ID “S3” of the transition destination at the time t1 is 50%×50%=25% (accurately, 25% is multiplied by the following attenuation rate γ). That is, the monitoring condition learning section 31 calculates the long-term transition rate of the attenuation type state transition matrix ID from the order transition rate of the state transition matrix T in accordance with the following (Numerical Formula 1).

D=T+γT²+γ²T³+γ³T⁴+ . . . γ^{∞-1}T^{∞} . . . (Numerical Formula 1)

Here, γ is a constant which is called the attenuation rate and is more than 0 and less than 1. A right-side first item (T) in the numerical formula 1 is the item which indicates the next step and a right-side second item (γT²) is the item which indicates two steps ahead.

As shown by (Numerical Formula 1), as the number of steps up to the transition destination is increased from the current step (time) (as it gets closer to the distant future), the weight of the attenuation rate γ is increased and thereby the influence of the order transition rate per step attenuates. Accordingly, it was decided to call it the attenuation type state transition matrix D in order to distinguish it from the state transition matrix T.

Incidentally, (Numerical Formula) can be deformed to (Numerical Formula 2) as follows. Here, E is a unit matrix.

D=T(E−γT)⁻¹ (Numerical Formula 2)

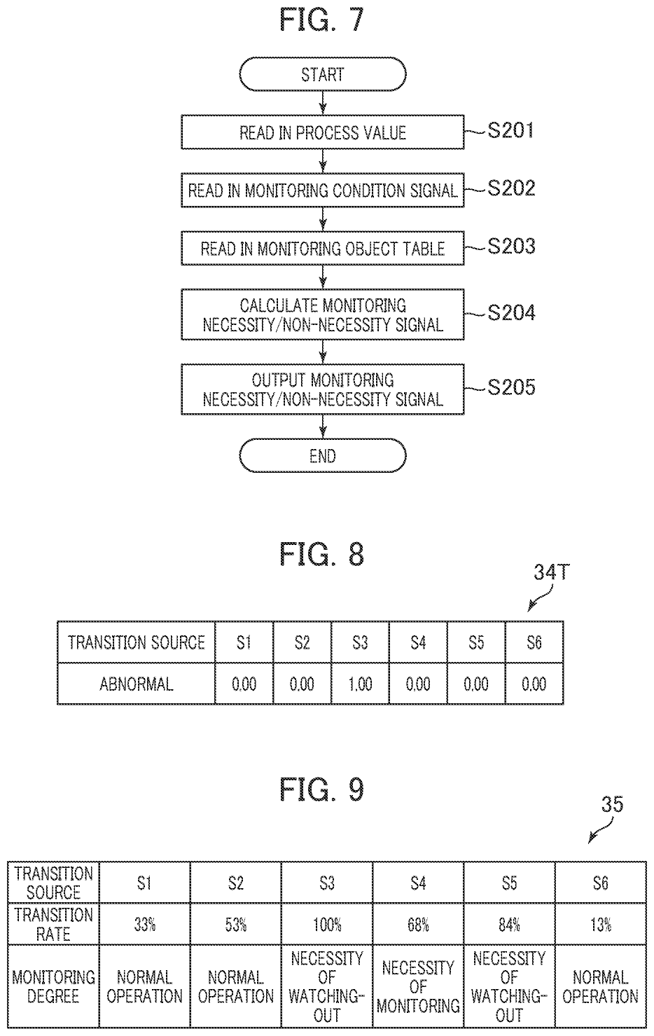

FIG. 7 is a diagram showing a flow of processing that the monitoring necessity/non-necessity decision section 34 performs.

The monitoring necessity/non-necessity decision section 34 reads in the process value 11 from the plant 29 (S201), reads in the monitoring condition signal 32 from the monitoring condition storage section 33 (S202), reads in the monitoring object table 34T which is input from an administrator in advance as a normal range decision matrix R (S203, details are in FIG. 8).

Then, the monitoring necessity/non-necessity decision section 34 obtains the current state ID from the current process value 11 as in S102 and calculates the monitoring necessity/non-necessity signal 35 when that current state ID was set as the transition source (S204, details are in FIG. 9). In calculation of this monitoring necessity/non-necessity signal 35, the monitoring condition signal 32 and the normal range decision matrix R are used.

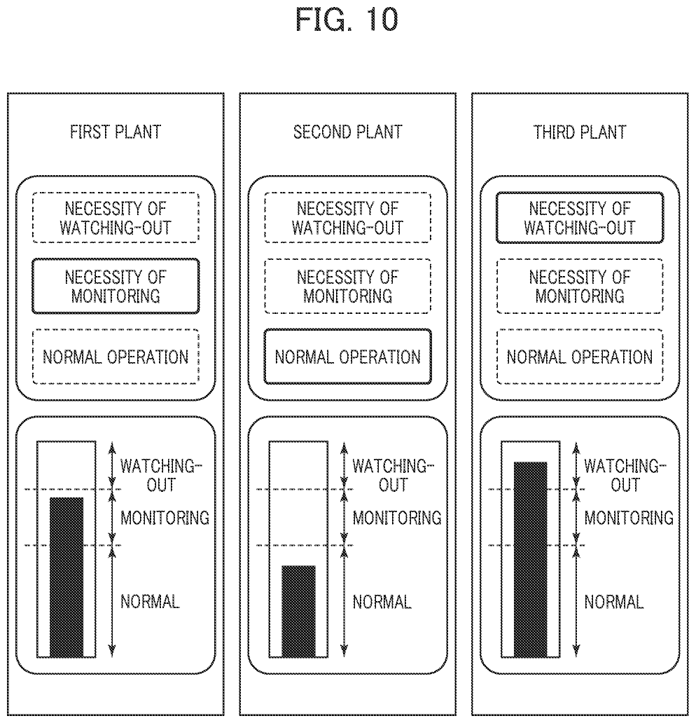

Further, the monitoring necessity/non-necessity decision section 34 transfers a result of the monitoring necessity/non-necessity signal 35 which was calculated in S204 to the monitoring room 39 and makes it display on the screen (S205, details are in FIG. 10).

FIG. 8 is the monitoring object table 34T which shows one example of the normal range decision matrix R.

The normal range decision matrix R is a matrix which stores whether each state ID of the transition source is in the normal range (the protection range) of the plant component or an out-of-range abnormal state. In the row of ABNORMAL, a value “0.00” indicates the inside of a normal range and a value “1.00” indicates the outside of the normal range and, in FIG. 8, the state ID “S3” is out of the normal range of the plant component.

FIG. 9 is a table which shows the monitoring necessity/non-necessity signal 35.

In this table, the current state ID (the transition source), the long-term transition rate when the state ID “S3” which is out of the normal range is set as the transition destination and the current-state monitoring degree which corresponds to the long-term transition rate are set in correspondence with one another as the monitoring necessity/non-necessity signals 35. That is, even when the current state ID is other than the state ID “S3”, a state ID which is higher than others in long-term transition rate to the future state ID “S3” needs more monitoring by the plant operator than others.

Accordingly, the monitoring degree was divided into three stages and the state ID that the long-term transition rate is more than 80% was defined as “NECESSITY OF MONITORING”, the state ID t the long-term transition rate is more than 60% was defined as “NECESSITY OF WATCHING OUT” and the state ID that the long-term transition rate is less than 60% was defined as “NORMAL OPERATION” in the order of the needs for monitoring. Thereby, the plant operator in the monitoring room 39 can conduct such explicit monitoring which depends on the monitoring degrees as to most preferentially monitor the components of the plant 29 that the current state IDs are S3, S5, to then monitor the component of the plant 29 that the current state ID is S4 and to exclude the components of the plant 29 that the current state IDs are S1, S2, S6 from monitoring objects.

Incidentally, in a case where deviation from the protection range is predicted when the monitoring necessity/non-necessity signal 35 indicates “NECESSITY OF MONITORING” and so forth, the monitoring necessity/non-necessity decision section 34 may transmit a control signal of the effect of “switching to the protection control circuit” to the plant 29 via the plant control section 24.

The monitoring necessity/non-necessity decision section 34 calculates the monitoring necessity/non-necessity signal 35 with the following (Numerical Formula 3).

V=DR^{tr} (Numerical Formula 3)

Here, the left side “V” of the Numerical Formula 3 indicates the long-term transition rate to outside of the normal range and tr indicates a matrix transpose symbol. For example, since the normal range decision matrix R in FIG. 8 is, only the state ID “S3” has the value “1.00”, a result that a column (a symbol 321) the transition destination of which is S3 in FIG. 6 is transposed and normalized with the (Numerical Formula 3) becomes the transition rate of the monitoring necessity/non-necessity signal 35 in FIG. 9.

FIG. 10 is a diagram of a screen which is displayed in the monitoring room 39.

On the display screen, a display column (the one that the current monitoring degree is emphasized in three buttons) of three stages of monitoring degrees which are shown in FIG. 9 and a display column (a bar graph) of the long-term transition rate of the monitoring necessity/non-necessity signal 35 are set in correspondence with each other per plant 29 (or per component of the plant 29).

Owing to this display screen, the plant operator can efficiently confirm a control status of the entire plant 29. For example, in FIG. 10, distribution of concentration force which fits the current status of the plant 29 becomes possible for the plant operator so as to watch out a third plant the most and to decrease the watching degree in the order of next coming first plant and second plant.

Incidentally, the monitoring necessity/non-necessity decision section 34 may notify the monitoring room 39 of various kinds of signals (1) to (3) which are exemplified in the following so as to appropriately let the plant operator confirm them as signals to be notified to the monitoring room 39, not limited to the monitoring necessity/non-necessity signal 35.

(1) A few-minutes-ahead predicated value of the process value 11 which was calculated by using an RNN (Recurrent Neural Network) and a simulator of Deep Learning. The plant operator who confirmed deviation of this predicted value from the protection range can understand switching from automatic control to manual control at an early stage.

(2) Information on real-time evaluation of the accuracy of the control law 22 (an internal model) which was learned by the control learning section 21. Thereby, when the accuracy of the internal model is deteriorated, the plant operator can instruct an update timing of the artificial intelligence control and can instruct to execute decision of switching to a protection circuit.

(3) A result of calculation of the peak value of each process value 11 in a case of assuming that a maximum manipulated variable is continuously input by a full break operation, a full throttle operation and so forth. Thereby, even in a case where the peak value deviates from the protection range, the plant operator can switch control.

In the present embodiment which is described above, the processing device 40 which mainly performs the industrial plant oriented intellectual control and intellectual monitoring was described. The monitoring condition learning section 31 of the processing device 40 learns in advance the relation between the control signal and deviation from the protection range and makes the monitoring condition storage section 33 store it. Then, the monitoring necessity/non-necessity decision section 34 obtains the monitoring necessity/non-necessity signal 35 which indicates the degree of necessity of monitoring in the current state of the process value 11 with reference to the monitoring condition storage section 33 and notifies the monitoring room 39 of the monitoring necessity/non-necessity signal 35.

Thereby, since the plant operator is, the necessity to perform the monitoring always concentratedly is lowered, a monitoring load on the plant operator can be reduced.

In addition, the learning unit 41 of the processing device 40 uses the operation data which is read out of the operation data storage section 12 as the learning data which is common between the automatic control system (the control learning section 21) and the manual control system (the monitoring condition learning section 31).

Thereby, even in a case where the monitoring condition learning section 31 is newly added to an intelligent control system into which the control learning section 21 has already been introduced as a first learning section as a second learning section, the necessity to develop new operation data and physical simulator is eliminated and man-hour which is necessary for additional introduction can be reduced.

Incidentally, the present invention is not limited to the aforementioned embodiment and various modified examples are included. For example, the aforementioned embodiment is the one which is described in detail for intelligible explanation of the present invention and is not necessarily limited to the one which is equipped with all the configurations which are explained.

In addition, it is possible to replace some of the configurations of one embodiment with configurations of another embodiment and, in addition, it is also possible to add a configuration of another embodiment to configurations of one embodiment.

In addition, it is possible to add/delete/replace another configuration to/from/with some of the configurations of each embodiment. In addition, the above-described respective configurations, functions, processing sections, processing means and so forth may be partially or entirely realized in hardware by designing them by, for example, an integrated circuit.

In addition, a processor may interpret and execute programs which realize respective functions and thereby the aforementioned respective configurations, functions and so forth may be realized in software.

Information on programs, tables, files and so forth which realize the respective functions can be held in a recording device such as a memory, a hard disc, an SSD (Solid State Disc) and so forth, or a recording medium such as an IC (Integrated Circuit) card, an SD card, a DVD (Digital Versatile Disc) and so forth.

In addition, control lines and information lines which are thought to be necessary for explanation are shown and all control lines and information lines are not necessarily shown in terms of the product. In reality, it may be thought that almost all the configurations are mutually connected.

Further, a communication means which connects together the respective devices is not limited to a wireless LAN and may be changed to a wired LAN and other communication means.

### REFERENCE SIGNS LIST

11 process value

12 operation data storage section

13 operation data

21 control learning section

22 control law

23 control law storage section

24 plant control section

25 manipulated variable (operation signal)

29 plant

31 monitoring condition learning section

31T state conversion table

32 monitoring condition signal (monitoring condition)

33 monitoring condition storage section

34 monitoring necessity/non-necessity decision section (monitoring necessity/non-necessity processing section)

34T monitoring object table

35 monitoring necessity/non-necessity signal

39 monitoring room

40 processing device (monitoring support device)

42 control unit

41 learning unit

1. A monitoring support device characterized by having:
a control law storage section in which a control law that a suitable operation signal is put into correspondence with a process value that operation data of a plant component is measured is stored;
a monitoring condition storage section in which a monitoring condition that a monitoring degree which indicates a degree of necessity/non-necessity of monitoring is put into correspondence with a range of the process values is stored;
a plant control section which obtains the operation signal which is to be output in accordance with the control law from the process value which is input and outputs it to the plant component;
a monitoring necessity/non-necessity processing section which obtains the monitoring degree which is to be output in accordance with the monitoring condition from the process value which is input and notifies a plant operator of it; and
a monitoring condition learning section which prepares the monitoring condition by putting the monitoring degree into correspondence with the range of the current process values on the basis of a probability of shifting from the current process value to the future process value when history data of the process value is input as learning data and makes the monitoring condition storage section store that monitoring condition.

2. The monitoring support device according to claim 1, characterized by further having a control learning section which prepares the control law with which the operation signal which is output is put into correspondence on the basis of history data of the process value which is input into the monitoring condition learning section as the learning data and makes the control law storage section store that control law.

3. The monitoring support device according to claim 1, characterized in that the monitoring necessity/non-necessity processing section makes it possible to distinguish monitoring degrees of three or more stages which include necessity of monitoring and non-necessity of monitoring as control of obtaining the monitoring degree and notifying the plant operator of it and thereby makes a display device display them.

4. The monitoring support device according to claim 3, characterized in that when the monitoring degree is the necessity of monitoring, the monitoring necessity/non-necessity processing section makes it output a protection control signal to the plant component via the plant control section.

5. A monitoring support method characterized in that
a monitoring support device has a control law storage section, a monitoring condition storage section, a plant control section, a monitoring necessity/non-necessity processing section and a monitoring condition learning section, wherein
a control law that a suitable operation signal is put into correspondence with a process value that operation data of a plant component is measured is stored in the control law storage section,
a monitoring condition that a monitoring degree which indicates a degree of necessity/non-necessity of monitoring is put into correspondence with a range of the process values is stored in the monitoring condition storage section,
the plant control section obtains the operation signal which is to be output in accordance with the control law from the process value which is input and outputs it to the plant component;
the monitoring necessity/non-necessity processing section obtains the monitoring degree which is to be output in accordance with the monitoring condition from the process value which is input and notifies a plant operator of it, and
the monitoring condition learning section prepares the monitoring condition by putting the monitoring degree into correspondence with the range of the current process values on the basis of a probability of shifting from the current process value to the future process value when history data of the process value is input as learning data and makes the monitoring condition storage section store that monitoring condition.
